(19) United States
(12) Patent Application Publication
(10) Pub. No.: US 2003/0097857 A1
(43) Pub. Date: May 29, 2003

(54) Method and device for expanding fused materials

(76) Inventor: Tjin Swan Oei, Jakarta (IN)

Correspondence Address: RANKIN, HILL, PORTER & CLARK, LLP, 700 HUNTINGTON BUILDING, 925 EUCLID AVENUE, SUITE 700, CLEVELAND, OH, 44115-1405, US

(21) Appl. No.: 10/182,879

(22) PCT Filed: Jan. 10, 2001
(86) PCT No.: PCT/IB01/00011

(30) Foreign Application Priority Data
Feb. 2, 2000 (CH) 203/00

(51) Int. Cl. C04B 5/06; C03B 19/08

(52) U.S. Cl. 65/20; 65/22

(57) ABSTRACT

The invention relates to a method and to a device for foaming molten materials (1), wherein molten material is processed into a melt film (6), foaming agent (3) is mixed into this melt film, this melt film is atomised by an atomiser (13), is deposited as a mixture (4) onto a foaming surface (15) where the mixture is foamed into material foam.

### BACKGROUND OF THE INVENTION

There are known various methods in order to produce glass foam from glass-forming materials. One differentiates between methods in which a powdery parent product releases foaming gases, for example by heating at melting temperature in a through-type furnace, and methods in which a melt directly during its cooling by way of an admixed foaming agent releases gases that foam the melt.

A first, common method in a glass-melting furnace first manufactures a special glass mixture. The glass mixture, after cooling and solidifying, is finely ground, mixed with foaming agent, filled in molds and, in a second thermal step, is again heated to temperatures in the region of the melting temperature of the glass where the glass, begins to foam by way of decomposition of the foaming agent. After cooling there is present a product that may be applied in the building industry for insulating purposes. The disadvantage of this method lies in the high manufacturing costs that originate from both thermal manufacturing steps.

Another method known from the iron industry is based on the direct foaming of ironworks slag out of the melt. The fluid slag at the same time, for example, together with water as a foaming agent is led in channels in which the water evaporates by way of the high slag temperature. On its way through solidifying slag the evaporated water causes the slag to foam. With this there arises a closed-pore, pumice-like product, the so-called foamed slag may be applied in the building industry for insulating purposes or also as gravel replacement in civil and underground engineering. With this method it is a disadvantage that one does not produce a really high-quality product with a uniform pore construction, which may be used today in the building trade and civil and underground engineering. Moreover, in a secondary reaction sulphur mixes with water into H₂S, which greatly limits the manufacture and the utilisation of the foamed slag.

With a further method, which on a large technical scale could not prove its value, a gas is dissolved in molten material. When the material solidifies later, the dissolved gas is again released in a directed manner, for example by a pressure reduction. The disadvantages of this method lie in the fact that the gas solubility is very heavily dependent on the composition of the melt, that fluctuations in the composition of the melt very greatly influences the product quality, and that the handling of melt products under pressure and at high temperatures is very difficult, complicated and dangerous.

With yet a further method a powder-like foaming agent is distributed into a melt and one attempts to retain the foaming gases arising from the foaming agent in the solidified product beyond the cooling phase. At the same time the melt must be liquid to stir in the foaming agent, which necessitates very high melting temperatures. The main problem to be solved is the fact that the foaming agent, indeed just at high temperatures, immediately after contact with the melt begins to form gases and subsequently thereto, becomes very difficult to admix foaming agent to the foam being formed. In order to achieve satisfactory pore homogeneity with a simultaneous low density, the mixing procedure must be affected very quickly and be concluded already before the gas formation. Such a delayed foaming has, until now, not been able to be achieved with known foaming agents. Finally, the stirring of the powder-like foaming agent into a melt of above 1200° C. represents a technical problem that is still to be solved.

The patent document DE 22 06 448 describes a method that, for the present invention, may be regarded as the next closest state of the art. With this method a melt is atomized and a foaming agent is admixed to the thus produced droplet mist of melt. For the atomization, a gaseous atomization agent is set under pressure, for example air or water vapour. The atomized melt is sprayed onto a horizontal belt on which it is foamed by way of contact with the foaming agent.

Unfortunately, this method has several disadvantages. One disadvantage results from the fact that the conveyor belt must be cooled for reasons of strength. With this the underside of the produced foam is also cooled. Therefore, on the underside of the foam less gas bubbles are formed, which leads to an irregular pore distribution of the product. A further disadvantage lies in the fact that the gas bubbles, on account of their lower density, have the tendency to rise upwards in the melt. This leads to a larger bubble number in the upper part of the foam layer wherein smaller bubbles connect into larger ones, which results in bubble inhomogeneity. A further disadvantage lies in the fact that a homogeneous mixture of a droplet mist of melt and a foaming agent cloud is only possible with a leaner than stochiometric foaming agent metering quantity. A part of the apportioned foaming agent settles in the foaming installation in a practically uncontrolled manner and, inasmuch as hot gas is located here, would let this foam, by which means the pore homogeneity is additionally worsened.

Here the subsequently described inventive method proves itself. By way of process management different from the techniques applied up to now, the disadvantages of the foaming from the melt fusion are alleviated. Therefrom results an inexpensive method, which produces foams of good quality.

### SUMMARY OF THE INVENTION

It is an object of the present invention to develop a method in which a foam may be foamed directly from a melt, resulting in a product having good pore homogeneity that may be produced with little expense. The method should be able to be carried out with a device that avoids the previously mentioned disadvantages such as: a plurality of thermal method steps, a non-uniform pore construction of the product, a fluctuation in the quality of the product caused by the method, a handling of melt products under pressure and at high temperatures, a stirring-in of powder-like foaming agent at a high temperature. The inventive method should be able to be carried out with common working techniques and be able to be integrated in known installations.

### BRIEF DESCRIPTION OF THE DRAWINGS

These and further features of the invention will be apparent with reference to the following description and drawings, wherein:

FIG. 1 schematically shows the exemplary method variant with a device for atomizing and mixing molten material with foaming agent and foaming the mixture;

FIG. 2 shows a part of a first embodiment of a device according to FIG. 1;

FIG. 3 shows a part of a further embodiment of a device according to FIG. 1.

### DETAILED DESCRIPTION OF THE PREFERRED EMBODIMENTS

For atomizing molten material at high temperatures basically two solutions are considered. A first solution entails atomizing by way of an atomizer while exploiting centrifugal force. A second solution entails atomizing with an atomizing agent, such as pressurised air, steam, or fluids, thus, for example, by way of two-component nozzles. The present invention is based on the first of these two solutions.

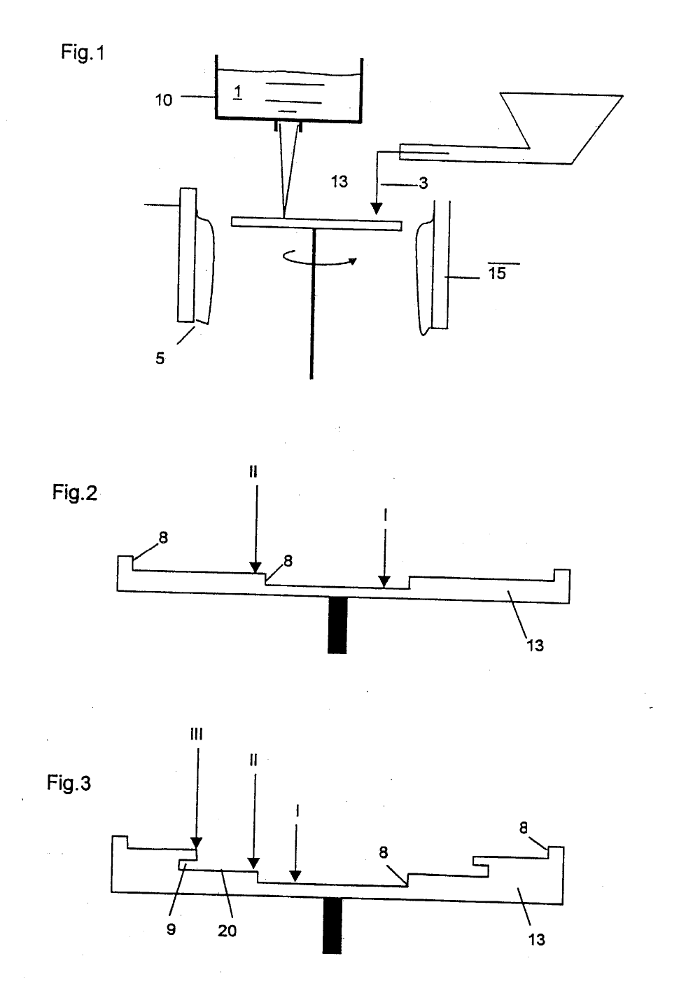

According to FIG. 1, molten material 1 is metered from a storage container 10. The storage container is, for example, a melting unit or a lined material container with an opening 12 for the molten material to flow out. Slag, for example steelworks slag, blast furnace slag, or slag from incineration installations is advantageously used. Other molten or high melting point materials such as glass may of course also be used within the framework of the present invention. Advantageously, the molten material contains oxides that may be reduced by carbon and release gases such as C0₂ or CO.

In the method variant of the invention according to FIGS. 1-3, a material jet flowing out of the supply container in a first step is processed into a melt with a large surface. The molten material flows as continuously as possible onto an atomizer 13. The atomizer is any body. For example the atomizer has the shape of a disk, roller, etc. According to FIG. 1 the atomizer is a horizontally rotating disk having a diameter of, for example, 1 meter. The material jet flowing out may be led onto a disk of such dimensions without problem. On account of the high centrifugal forces prevailing on the disk, molten material located on the disk is processed into a thin melt film 6 of, for example, 0.5-1 mm thickness with a large external surface. The atomizer may be heated or cooled in order to set the viscosity of the melt film by variation of the temperature of the atomizer.

The setting and control of the temperature of this melt film within a material melting range is effected, for example, by the supply of heat by auxiliary agents such as hot gas. Advantageously, for avoiding a cooling which is too rapid one may provide a radiation insulation of the whole device. The atomizer may also be separately heated, for example by way of a burner directly onto the melt film. If cooling is required because the molten material has a temperature that is too high, then this may be provided very simply by auxiliary agents such as water or air. This is affected by admixing into the molten material and/or separate cooling of the atomizer, for example by cooling the rear side of the atomizer. All these temperature controls may be carried out simply and may be adapted to different large material melting ranges of various applied materials. Basically, it is the case that the larger the material melting range of the applied material, the simpler the execution of the method according to the invention.

The foaming agent 3 is metered onto an atomizer. For example a powder-like, fine-grain foaming agent is metered via a metering means 24 onto the disk according to FIG. 1 and, on account of the prevailing centrifugal forces, is mixed into the melt film. As a foaming agent one may use any material that, when excited, produce gases. Such an excitation for producing gases may be affected in various ways and manners. For example, excitation may be affected by heating the foaming agent in direct contact with the molten material, or by thermal decomposition of the foaming agent (for example CaCO₃), or by chemical reaction with the molten material (for example according to a reaction (C+Fe₂O₃→2FeO+CO_{(g)}). As a foaming agent for steelworks slag with a melting temperature above 1200° C. usual ground limestone, which at approx. 850° decomposes into CaO and gaseous CO₂, may be used. Advantageously, small concentrations of the foaming agent are metered into the melt film. Such a metering takes place, for example, at a concentration of approximately 1% (1-10 g foaming agent per 1 kg of molten material) into the melt film. Advantageously, the foaming agent contains carbon, so that 0.2-2 g of carbon is metered into 1 kg of molten material.

The foaming agent may be uniformly incorporated into the surface of the melt film so that any intimate mixture of the two media may be achieved. There is affected no local excess metering of foaming agent with the local formation of larger bubbles, such as when mixing foaming agent into a melt droplet mist. According to the present method variant, in a simple way and manner a very homogeneous foaming agent distribution in the molten material may be achieved.

This thin film of molten material and metered/mixed foaming agent still under the influence of the centrifugal force is centrifuged and at the same time broken up into fine droplets. The admixing of the foaming agent may also be affected only after the separation of the melt film from the atomizer, however under the condition that the produced film is still retained laminar and has not yet broken up into individual droplets. Otherwise, similar problems as with the atomization with a melt droplet mist arise, wherein a part of the foaming agent must penetrate the mist and at the same time contact melt droplets and reacts in the heat contact in the mist and precipitates. The manner of mixing of foaming agent onto a melt film with a large surface is very effective. Only very little foaming agent is lost, which leads to a considerable saving of foaming agent. With the knowledge of the present invention-there are offered several comprehensive variation possibilities to the man skilled in the art. For example, it is possible to separately deposit the foaming agent onto an atomizer. When using an atomizer according to FIG. 1 the centrifugal force exerted onto the melt finely scatters the melt and the foaming agent and centrifuges it outwards over the edge of the disk.

The fine droplets of melt and mixed foaming agent are collected on a foaming surface 14 and processed into a mixture 4 of molten material and foaming agent. A further, additional, intimate mixing of the melt and the foaming agent is effected. This mixture, for example, flows downwardly under the effect of gravity on the foaming surface. The foaming surface is any arcuate or plane surface. For example, the foaming surface is the inner wall of a tube. In the embodiment shown in FIG. 1, the foaming surface is the vertically standing inner wall of a heat-resistant hollow cylinder. This hollow cylinder forms a type of reaction chamber. It may widen upwardly or downwardly in the manner of a funnel. It may also be heat-insulated or be heated/cooled in order thus to increase or reduce the flow speed of the mixture of molten material and the foaming agent on the wall of the tube. Also in this way and manner heat losses to the outside with an inhomogeneous pore formation are prevented. For this, with the knowledge of the present invention there are many variation possibilities open to one skilled in the art. For example, removal of the compacted mixture by forces other than gravity is also possible. Possible forces are the centrifugal force, i.e. the foaming surface may be designed as a rotating disk directed horizontally or obliquely.

After contact of the media of the melt and the foaming agent on the foaming surface, the gas formation and the reaction into a material foam 5 take place. For such a foaming the sojourn time on the atomizer of the foaming agent mixed into the melt film is too short. The foaming is not affected until on the foaming surface. Bubbles that have arisen flow together with the molten material downwards according to gravity or, where appropriate, as a result of the buoyancy force are moved upwards in the counter direction of the flow direction of the material foam. The bubbles that form on account of the foaming procedure may not leave the material foam being created, since new mixture constantly continues to flow upwards. After finishing the reaction in the inside of the reaction chamber the homogeneous material foam leaves the hollow cylinder for example on account of its weight.

The advantages of using a tube or a vertical wall as a foaming surface are evident when one observes the movement of a bubble in comparison to the position of the foam. If one sprays on a horizontal surface, then bubbles in the foam which have arisen on account of chemical reactions rise and leave the foam, assuming that the outer skin is not yet too tough as a result of cooling. These bubbles are then ineffective for the foaming process and thus contribute to an increase of the foam density. However, if the outer skin has cooled so greatly that the bubbles may no longer penetrate the outer skin, then the bubbles collect below the outer skin and lead to large-pored, mechanically instable regions and worsen the foam quality or lead to a considerable reject rate. On the other hand, if one sprays onto a vertical wall, the bubbles that arise on account of the acting forces are not displaced to the outer skin of the foam (as this is the case when spraying onto a horizontal surface) but rise indeed in the foam itself and may not leave this. By way of this the foam density is reduced and the foam has a homogeneous pore structure everywhere. Furthermore, all bubbles take part in the foam formation so that the average quantity of foaming agent is reduced. If this wall is additionally heated from the rear, the foam temperature may be exactly controlled and optimized, similar to the methods that firstly grind and foam coming from a cooled condition. If, in contrast, the wall is cooled, then there arise toroidal strands of 1-10 cm diameter that are quenched by the low wall temperature and may be varied in diameter in a targeted manner. These strands, after reaching a certain thickness, fall downwards by gravity.

FIG. 2 shows a part of an embodiment form of an atomizer of the device according to FIG. 1. With highly viscous melts, for example melts with a temperature near the melting point, the internal forces of the melt may be so large that they are centrifuged outwards by the centrifugal force in large droplets without forming a film. An encouragement of the formation of the melt film (in order to prevent such a droplet formation) is affected by incorporating at least one concentric, raised step 8 on the atomizer or the surface of the disk. The molten material is, for example, metered at an outer position II in FIG. 2 and 3. Since the melt must overcome at least one step, at the vertical wall of the step the melt will be processed by the centrifugal force into a thin film with a large surface, without possibility of escape.

For foaming glass or slag one may use silicon carbide SiC as a foaming agent. This material reacts with oxides of the melt and, at the same time, forms gaseous CO or C0₂.

A possible reaction may at the same time take place with Fe₂O₃:

SiC+3Fe₂O₃→SiO₂+6FeO+CO_{(g)}

Under certain circumstances the melt does not receive the reaction partner (here Fe₂O₃) for the foaming agent in a sufficient quantity. For example, blast furnace slag contains practically no Fe₂O₃. Therefore, the Fe₂O₃ must then be additionally admixed to the melt if the above reaction is to take place.

When using a rotating disk as an atomizer the disk may also be applied as a mixer not only for mixing the foaming agent but also for mixing at least one further reaction agent. For example, molten material is first metered onto the disk from the inside to the outside (position I in FIG. 2 and 3), then for example a powder-like reaction agent such as Fe₂O₃ is deposited onto the produced melt film (position II in FIG. 2 and 3), and thereupon the foaming agent is metered to the melt/Fe₂O₃ mixture (position III in FIGS. 2 and 3). The further reaction agent is, for example, admixed to the melt at one step of the disk. For example, so much further reaction agent is metered that the mixture to be foamed contains 2-20% Fe₂O₃. From the inside of the disk to the outside, the metering positions are arranged as follows: melt, Fe₂O₃, foaming agent.

FIG. 3 shows a part of a second embodiment of an atomizer of the device according to FIG. 1. For encouraging the formation of the film of melt and in order to increase the sojourn or travel time of the melt on the disk on a concentric step of the rotation disk there is incorporated at least one concentric groove 9 open toward a center of rotation. The groove 9 fills with melt and the sojourn time of the melt on the disk increases. By way of the radial movement of the melt on a run-in part 20 towards the groove there is formed a turbulent flow within the groove with an intensive mixing effect, by means of which the Fe₂O₃ ideally mixes with the melt and is melted. By way of such a means the previous, additional mixing unit for mixing the melt and Fe₂O₃ may be unnecessary.

The material foam cools, solidifies, and is, for example, collected in a collecting container. For this, a continuously running belt may be used. The running belt may, where necessary, be cooled. Alternatively, the running belt may be coated in a heat-resistant manner or covered with a protective material that is constantly deposited, such as sand. Such a conveyor belt permits the foamed melt to be continuously transported away. Many possibilities for this further processing are available to one skilled in the art. It is thus possible to manufacture irregularly shaped material chunks with a greater or lesser size. It is likewise also possible to hold the material foam in uniform molds and, for example, to process material foam plates. The material foam may then be processed further into insulating bricks.

The pore construction of the material foam, its degree of foaming, may be set by way of a simple setting of the ratios of material particles to foaming agent. The type of molten material, the type of the applied foaming agent, the size of the charges through the device (for example 2-10 tons/h) as well as the prevailing temperatures and temperature gradients are further parameters for the controlled manufacture of material foam with a uniform pore construction.

1. A method for foaming molten materials (1), characterised in that the molten material is deposited onto the surface of a movable atomiser (13) and on this surface is processed into a melt film, foaming agent (3) is mixed into the melt film, the melt film (6) is atomised by the movable atomiser and as a mixture (4) is deposited onto a foaming surface (15), and the mixture on the foaming surface (15) foams into material foam (5).

2. A method according to claim 1, characterised in that the foaming agent is mixed into a melt film with a large surface in a metered manner.

3. A method according to claim 1, characterised in that a foaming agent is used which releases gases on heating.

4. A method according to claim 1, characterised in that a foaming agent is used which contains carbon (for example SiC).

5. A method according to claim 4, characterised in that per 1 kg of molten material one uses a foaming agent which contains 0.2-2 g carbon.

6. A method according to claim 4, characterised in that the molten material contains oxides, said oxides being reduced by the carbon of the foaming agent and which release gases C0₂ or CO.

7. A method according to claim 2, characterised in that apart from the foaming agent at least one further reaction agent is metered into the melt film.

8. A method according to claim 7, characterised in that as a further reaction agent Fe₂O₃ is used.

9. A method according to claim 1, characterised in that the atomiser is heated or cooled and that the viscosity of the melt film is set by variation of the temperature of the atomiser.

10. A method according to claim 9, characterised in that the atomiser is heated or cooled by auxiliary agents.

11. A method according to claim 1, characterised in that the vertically standing inner wall of a hollow cylinder is used as a foaming surface.

12. A method according to claim 11, characterised in that the foaming surface is heated or cooled and that the flow speed of the mixture or of the material foam is set by variation of the temperature of the hollow cylinder.

13. A method according to claim 1, characterised in that slag, glass, blast furnace slag or waste incineration slag is used as a molten material.

14. A device for foaming molten materials (1), characterised by a surface of a movable atomiser (13), a movable atomiser (13) for the continuous processing of molten materials into a melt film (6) on the surface of the atomiser, a metering means (24) for metering foaming agent (3) into the melt film, a movable atomiser for atomising the melt film mixed with the foaming agent, and a foaming surface (15) for accommodating the mixture and for foaming the mixture on the foaming surface into material foam (5).

15. A device according to claim 14, characterised in that the atomiser is a horizontal, rotating disk which processes and atomises the molten material into a melt film on account of the centrifugal forces on the disk.

16. A device according to claim 15, characterised in that the disk comprises at least one concentric step (8) or at least one concentric groove (9) open towards the rotation centre.

17. A device according to claim 14, characterised in that the foaming surface is a vertically standing hollow cylinder on which the mixture or the material foam flows away by way of gravity.

18. A device according to claim 17, characterised in that the hollow cylinder is widened to the top or bottom in a funnel-like manner.
